(19) United States
(12) Patent Application Publication
(10) Pub. No.: US 2026/0019147 A1
(43) Pub. Date: Jan. 15, 2026

(54) SYSTEM AND METHOD TO SUPPORT AUTOMATIC RADIO-FREQUENCY (RF) GATEWAY COMPONENT FAILOVER IN A DATA COMMUNICATION NETWORK

(71) Applicant: Hughes Network Systems, LLC, Germantown, MD (US)

(72) Inventors: Nimesh AMBESKAR, Germantown, MD (US); Ashritha Mohan RAM, Gaithesburg, MD (US); Hsiu-Chu HUANG, Derwood, MD (US); Ahn JINYOUNG, Germantown, MD (US)

(73) Assignee: Hughes Network Systems, LLC, Germantown, MD (US)

(21) Appl. No.: 18/766,766

(22) Filed: Jul. 9, 2024

(51) Int. Cl. H04B 7/185; H04L 12/66

(52) U.S. Cl. CPC H04B 7/18519; H04L 12/66

(57) ABSTRACT

A data processing system and method for providing modem backup in a radio frequency (RF) gateway of a satellite communication system, wherein the system and method provide for grouping modems of the RF gateway into a redundancy group configuration comprised of a plurality of primary modems and one spare modem, preconfiguring the spare modem with configurations to store for each primary modems of the redundancy group configuration, detecting that one of the primary modems has become a failed primary modem due to a fault condition, and performing a switchover process to command the spare modem to perform a dynamic reconfiguration to take over operations performed by the failed primary modem after the fault condition has been detected using the configurations for the failed primary modem that have been preconfigured into the spare modem prior to detecting the fault condition.

### TECHNICAL FIELD

The present disclosure is related generally to satellite communication systems, and, in particular, to RF gateway redundancy schemes for gateway modems in satellite communication systems.

### BACKGROUND

Modern satellite communication systems provide a robust and reliable infrastructure to distribute data across vast distances, especially in remote areas where traditional networks, such as cable and cellular networks, are unreliable and/or unavailable. Significant time and effort have been spent in trying to find ways to increase the reliability and availability of satellite communication systems. RF gateways include the hardware and software needed to transmit data to and receive data from a satellite. RF gateways are susceptible to outages and performance degradation due to certain environmental factors and weather conditions.

The modulators and demodulators, aka modems, in the RF gateway of a data communication network operate at the physical layer of the system. These modems are hardware subsystems that run complex real time firmware and software typically on an embedded platform. Such complex sub systems are more susceptible to failures compared to software sub systems that drive upper layer functionality. Gateway modem failures lead to network service outages that could have severe impact on the overall service availability of the system. Therefore, it is desirable to provide automatic and highly reliable redundancy capability at the RF gateways for such gateway modems. Additionally, the switchover time of a failed modem to be available again for traffic processing determines the impact on the service due to the failure.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions may include grouping modems of the RF gateway into at least one redundancy group comprised of a plurality of primary modems and at least one spare modem, preconfiguring the at least one spare modem in the RF gateway with primary modem configurations for each of the plurality of primary modems of the at least one redundancy group, detecting that one of the plurality of primary modems has become a failed primary modem due to a fault condition, and performing a switchover process to command the at least one spare modem to perform a dynamic reconfiguration to take over operations performed by the failed primary modem after the fault condition has been detected using the configurations for the failed primary modem that have been preconfigured into the at least one spare modem prior to detecting the fault condition.

In another general aspect, the instant disclosure presents a method of grouping modems of the RF gateway into at least one redundancy group comprised of a plurality of primary modems and at least one spare modem, preconfiguring the spare modem in the RF gateway with for each of the plurality of primary modems of the at least one redundancy group, detecting that one of the plurality of primary modems has become a failed primary modem due to a fault condition, and performing a switchover process to command the at least one spare modem to perform a dynamic reconfiguration to take over operations performed by the failed primary modem after the fault condition has been detected using the configurations for the failed modem that have been preconfigured into the at least one spare modem prior to detecting the fault condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example satellite communication system in which the RF gateway redundancy schemes for the gateway modems disclosed herein may be implemented in accordance with aspects of the disclosure.

FIG. 2 shows a redundancy group configuration in accordance with aspects of the disclosure.

FIGS. 3A and 3B show interactions between a gateway configuration tool and gateway configuration manager module (GCM) and a spare modem, including a modem controller software (MCS), in a redundancy group configuration shown in FIG. 2 in accordance with aspects of the disclosure.

FIG. 3C shows an example of a GCM module in accordance with aspects of the disclosure.

FIG. 4 shows normal operations for a redundancy group configuration shown in FIG. 2 in accordance with aspects of the disclosure.

FIG. 5 shows a failover operation for a redundancy group configuration shown in FIG. 2 in accordance with aspects of the disclosure.

FIG. 6 shows a flowchart of an example method for backing up RF gateway modems in a satellite communication system in accordance with aspects of the disclosure.

FIG. 7 is a block diagram illustrating an example software architecture, various portions of which may be used in conjunction with various hardware architectures herein described in accordance with aspects of the disclosure.

FIG. 8 is a block diagram illustrating components of an example machine configured to read instructions from a machine-readable medium and perform any of the features described herein in accordance with aspects of the disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Modern satellite communication systems provide a robust and reliable infrastructure to distribute data across vast distances, especially in remote areas where traditional networks, such as cable and cellular networks, are unreliable and/or unavailable. Satellite communication systems have become an essential resource for many applications and services, including television, telephone, radio, internet, and military applications, due to the global connectivity and high data transmission rates provided by these systems. Due to the widespread use and often critical nature of satellite communication services, significant effort has been expended in finding ways to improve reliability, efficiency, and quality of service of satellite communication systems.

One component of a satellite communication system that is crucial in terms of reliability, efficiency, and quality of service of the system is an RF gateway. RF gateways includes the hardware and software needed to transmit data to and receive data from a satellite. Because RF gateways are typically associated with and provide satellite communication services to a large number of satellite terminals (i.e., customer premises equipment (CPEs)) at the same time, the failure of a single RF gateway, or the failure of components such as modems within a RF gateway, can adversely impact the services provided to a large number of customers. This is exacerbated by the fact that the frequency bands used for data transmission to and from a satellite are susceptible to degradation/attenuation (e.g., rain fade) due to certain environmental and/or weather-related conditions.

The following discussion provides detailed method and architecture to achieve fast and reliable redundancy for RF gateway components, particularly RF gateway modems. The architecture includes both software and hardware elements at RF gateways. In particular, the hardware elements include redundant spare modem hardware. In accordance with aspects of the present disclosure, this spare hardware is designated to take over from one of a plurality of primary modems arranged in a 1:N redundancy grouping with the spare modem such that one (1) modem is designated as a spare modem in a group of N primary modems.

The software elements include a central arbiter, hereinafter referred to as a gateway configuration manager (GCM) that controls and commands the switchover of the primary modems to the spare modem within a redundancy group configuration. Each of the modems (primary and spare) has an agent (hereinafter referred to as a bootstrapper module) that is responsible to relay the current state of the modem to the GCM. Each of the primary modems monitor, using modem software known as modem controller software (MCS), the health of its various components indicating a failure of one or more of the components to the GCM via the bootstrapper module. The spare modem dynamically takes over the failed primary modem's identity when commanded by the GCM. The GCM can also monitor the availability of the primary modems using heartbeat messages and can initiate a switchover operation to the spare modem if one of the primary modems is unresponsive. The dynamic reconfiguration of the spare modem allows for a faster switchover of the failed primary modem to a spare modem.

The failover method constitutes of two parts: (1) detection of primary modem failure in the redundancy group configuration; and (2) auto switchover of the failed primary modem to its designated spare modem in the redundancy group configuration. The following disclosure describes a detailed system and method including provisioning (configuration) of the spare modem, failure detection in the primary modems and dynamic reconfiguration of the spare modem in the redundancy group configuration upon failure of one of the primary modems in the redundancy group configuration.

The technical solutions described herein address the technical problem of inefficiencies and difficulties associated with backing up RF gateway modems in a satellite communication system. The technical solutions provide RF gateway modem redundancy schemes that reduce switching times and promote reliable service during transitions from a failed primary modem to a spare modem in the redundancy group configuration.

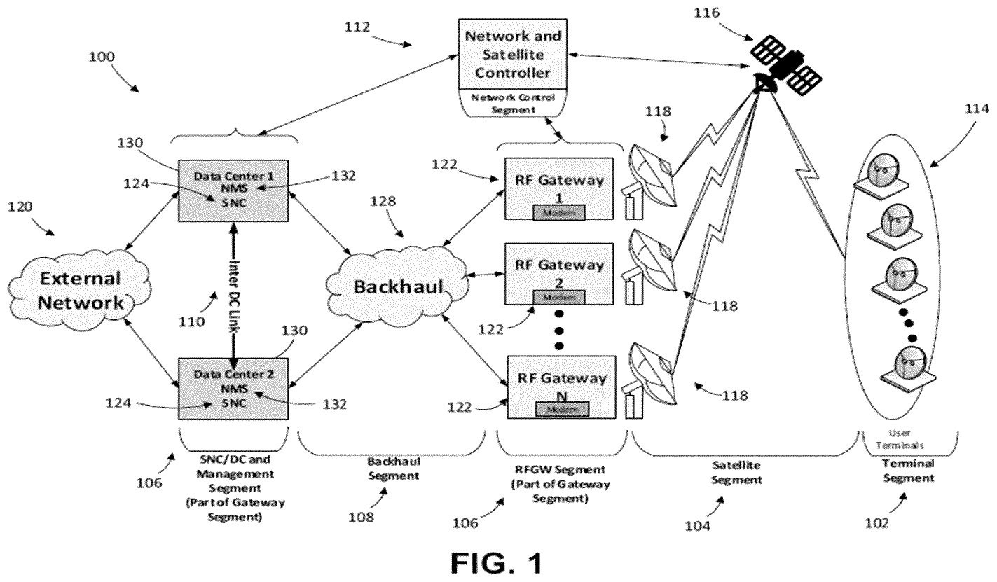

FIG. 1 shows an example satellite communication system 100 in which the RF gateway redundancy scheme according to the present disclosure may be implemented. The satellite communication system 100 includes a terminal segment 102, a satellite segment 104, a gateway segment 106, a backhaul segment 108, an inter-DC (data center) or SNC (satellite network core) link segment 110, and a network control segment 112. The terminal segment 102 includes satellite terminals 114 and other components that enable end users to connect to the satellite communication system 100. Satellite terminals 114 may be used at a residence or place of business to provide a user with access to the Internet. Satellite terminals 114 typically include an outdoor unit (ODU) that includes an antenna, such as a satellite dish for receiving RF signals from and transmitting RF signals to a satellite 116, and an indoor unit (IDU), such as a set-top box or similar type of equipment, that includes a transceiver, a controller, memory, local server, and other types of equipment which enable data to be transmitted and received via the ODU. Satellite terminals 114 enable client devices (not shown), such as computers, smart phones, tablets, televisions, and the like, to connect to access the services provided by the satellite communication system 100.

The satellite segment 104 provides connectivity between the terminal segment 102 and the gateway segment 106. The satellite segment 104 includes at least one satellite 116 via which data is transmitted between the satellite terminals 114 and RF components for the gateway segment 106. Satellite 116 may be any suitable type of communications satellite, such as a bent-pipe design geostationary satellite, which is capable of supporting data transmission in one or more frequency bands, such as C, Ku, Ka, Q, V, etc. The satellite segment 104 also includes the radio-frequency terminals (RFTs) and antennas (collectively referred to as RFTs 118) which are located at a gateway site with RF gateway components of the gateway segment 106. Communication between the satellite terminals 114 and the RFTs 118 are established via beams (e.g., spot beams) emitted by the satellite. Communication channels include an outroute channel which includes a forward uplink for transmitting data from a gateway to satellite 116 and a forward downlink for transmitting data from the satellite 116 to a satellite terminal. Communication channels also include an inroute channel which includes a return uplink for transmitting data from satellite terminals 114 to satellite 116 and a return downlink for transmitting data from the satellite 116 to the gateways.

The gateway segment 106 includes devices and components required to interface with the RFTs 118 of the satellite segment 104. The gateway segment 106 also includes network communication components needed to establish connectivity to the external network 120 (e.g., Internet). The gateway segment 106 has two logical components that can be deployed at the same or different sites: (1) RF gateways 122 and (2) Satellite Network Cores (SNCs) 124. An RF gateway 122 includes computing hardware and RF communication components for interfacing with the RFTs 118 and communicating via the satellite 116. RF communication components include at least one modem for converting analog data to digital data and vice versa. As discussed below, switching out failed primary modems in the RF gateways 122 for spare modems to allow for continued smooth operations is an important aspect of the present disclosure. SNCs 124 include hardware and software components for implementing the link layer, network layer, and management layers which enable data communication between RF gateways 122 and the external network(s) 120 via backhaul network 128. In embodiments, SNCs 124 are implemented in data centers 130. A data center corresponds to the physical site or location where SNCs are hosted. For example, SNC 124 is hosted at DC 130.

The backhaul segment 108 provides connectivity between RF gateways 122 and SNCs 124. The backhaul segment 108 includes networking components and infrastructure components for implementing a backhaul network 128 via which data communications between RF gateways 122 at gateway sites and SNCs 124 at data centers 130 are transmitted. The backhaul network 128 may also be used to provide remote access for network management system components of the network control segment 112. The inter-de link segment 110 provides connectivity between data centers 130. The inter-de link segment 110 includes networking components and network infrastructure components that enable secure data communications.

The network and satellite controller 112 includes a network control segment (NCS) and a satellite control facility. The NCS includes the central and distributed components required to manage the terminal segment 102 and gateway segment 106 (e.g., the RFGW segment and SNC/DC segment) components. In embodiments, the network control segment in the network and satellite controller 112 provides control signals, as shown in FIG. 1, to a network management system (NMS) 132 that provides tools for managing the satellite communication network and the terminals in the network. The NMS 132 may be responsible for managing all aspects of terminals within the system, including provisioning and commissioning of terminals. In embodiments, the NMS 132 may be hosted at one or more data center sites 130. The network and satellite controller 112 also provides control signals to the satellite 116, as shown in FIG. 1, to provide control of the satellite segment 104.

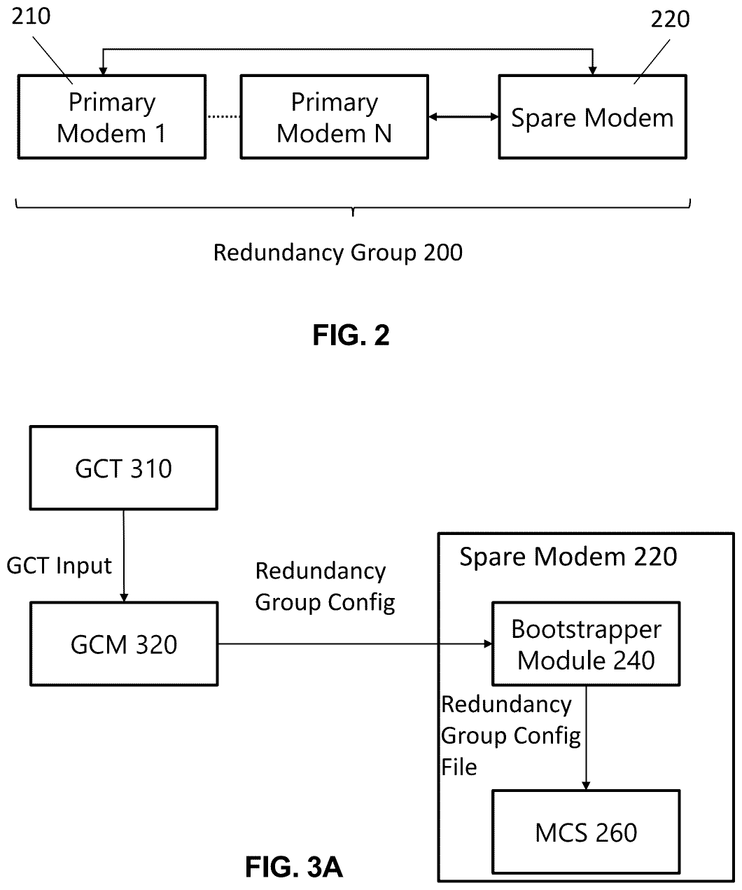

The satellite communication system 100 is configured to implement an RF gateway modem redundancy scheme. Provisioning redundancy for the modems at the gateway includes creation of redundancy groups such as redundancy groups 200 of FIG. 2. As shown in FIG. 2, each of the redundancy groups 200 can be constituted by N primary modems 210 and a spare modem 220 in a N:1 arrangement (e.g., a plurality N of primary modems 210, where N is greater than 1, to 1 spare modem. Also, although a N:1 relationship of plural primary modems to one spare modem is described herein, the redundancy groups 200 can be set up to have more than one spare modem (e.g., N:2, where N is greater than 2, etc.), so long as each spare modem 220 includes the configurations of a plurality of primary modems 210.

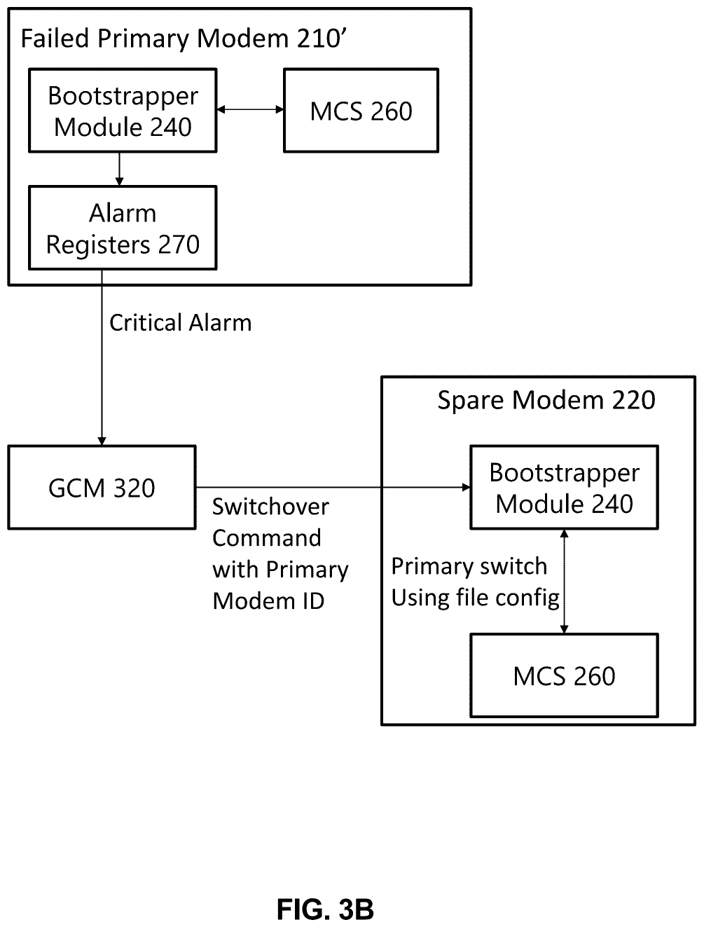

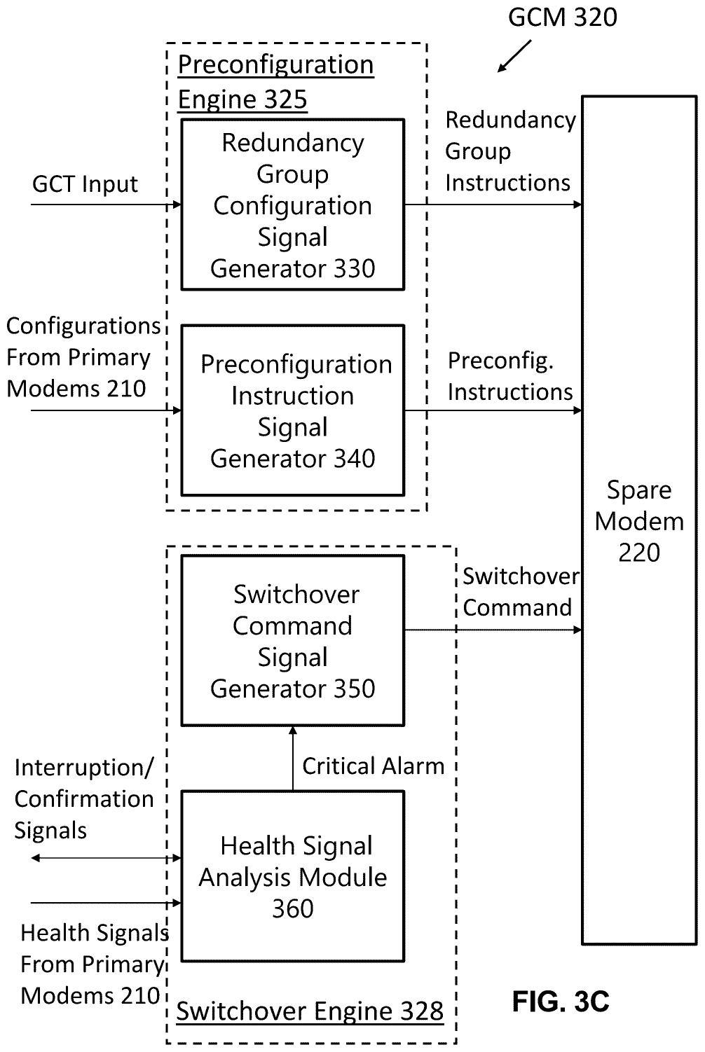

In FIG. 2, the spare modem 220 can be constructed to have the same structure as the primary modems 210 but is designated by the GCM module 320 (see FIG. 3) to take over the identity of one of the primary modems 210 in the redundancy group 200 (and thus be a spare modem rather than an original primary modem). As such, any of the original primary modems can be designated as a spare modem for purposes of setting up the redundancy group 200. The spare modem 220 after failover services has the exact same inroute/outroute channels as the failed primary modem 210 of the redundancy group 200. The modems 210 and 220 of the redundancy group 200 can all be in the same gateway of FIG. 1 (e.g., RF Gateway 1) or could be in different gateways of FIG. 1 (e.g., some of the primary modems 210 could be in RF Gateway 1 and others in RF Gateway 2, while the spare modem is in one of the other RF Gateways). In any case, an aspect of the present disclosure is for each spare modem 220 to be preconfigured with configurations for a plurality of the primary modems 210 in the redundancy group 200 so that the spare modem 220 can rapidly take over the operations of any one of a plurality of primary modems 210, if a fault condition is noted in any one of the primary modems 210.

FIG. 3A shows interactions between a gateway configuration manager module (GCM) 320 and a spare modem 220 in a redundancy group 200 shown in FIG. 2 in accordance with aspects of the disclosure. Specifically, FIG. 3A shows the use of a gateway configuration tool (GCT) 310 and the GCM module 320 to set up the redundancy groups 200. The GCT 310 generates mapping of the primary modems 210 and its one or more redundant spare modems 220. This configuration from the GCT tool 310 is input to the GCM 320 which is then passed on to the modem. The modem is then designated by the GCM as the spare modem 220 via a redundancy group configuration file which contains a list of primary modems 210 that the spare modem 220 can take over. As part of the provisioning, the designated spare modem 220 learns its redundant modem role via configurations from the GCT 310 and GCM 320 for each of the primary modems 210 within the same redundancy group 200.

An aspect of the design set forth in the present disclosure for fast switchover from a failed primary modem 210 in the redundancy group 200 to the spare modem 220 for the group 200 is the advance learning by the spare modem 220 of the current configuration of all the primary modems 210 in its redundancy group 200. The spare modem 220, when running as a backup modem, monitors and learns the current configuration of all primary modems 210 in its redundancy group 200. The configuration files from the GCM 320 of primary modems 210 in the group 200 are made available to the modem controller software (MCS) 260 of the spare modem 220 via a bootstrapper module 240 to the spare modem 220. The bootstrapper module 240 can be included in the spare modem 20 (as shown in FIG. 3A) or can be a separate module accessible to the spare modem 220.

The spare modem 220 then preloads and maintains the configurations of all of the primary modems 210 within a redundancy group 200 into a memory, such as a RAM (not shown), in the spare modem 220. Alternatively, the memory for the spare modem 220 can be located outside of the spare modem 220, as long as it is accessible to the spare modem 220 for storage of the configurations of a plurality of the primary modem 210 of its redundancy group 200. The configurations of the primary modems 210 include analog RF and digital channel reconfiguration. They also include IP address, data and management path IPs, programming of LAN interfaces and Srv6 (Segment Routing IPv6 protocol) route configurations. It is noted that, as part of the spare modem 220 learning all of the configurations, the spare modem 220 learns the IP addresses and Srv6 routes of each of its primary modems in advance.

By virtue of this pre-configuration of the spare modem 220, the primary modem configurations are then ready to be applied to the hardware, such as the MCS 260, and other interfaces of the spare modem 220, as soon as the spare modem 220 receives a switchover indicator from GCM 320 to take over operations from a failed one of the primary modems 210. This preloading of validated configurations in the memory of the static modem 220 allows for a dynamic and fast re-configuration of the static modem 220 to take over operations for a failed primary modem 210 within the same redundancy group 200.

FIG. 3B shows interactions between a failed primary modem 210′, the gateway configuration manager module (GCM) 320 and the spare modem 220 in a redundancy group 200 shown in FIG. 2 to implement switching the operations of the failed modem 210′ to the spare modem 220 based upon a command of the GCM 320 to make the switch. As can be seen in FIG. 3B, when a fault is detected in one of the primary modems 210 of the redundancy group 200, that modem becomes a failed primary modem 210′. As shown in FIG. 3B, when a primary modem 210 determines that it has become a failed primary modem 210′ due to some fault condition (e.g., hardware, firmware and software fault), a critical alarm is sent from the failed primary modem 210′ to the GCM 320. The GCM 320 receives this critical alarm and generates a switchover command signal to the spare modem 220. This switchover command signal includes a primary modem ID that corresponds to the failed primary modem 210′. In other words, this primary modem ID identifies which of the primary modems 210 in the redundancy group 200 has failed. Each of the primary modems 210 has its own distinct primary modem ID that is provided to the GCM 320 as part of the mapping from the GCT 310, and is provided to the spare modem 220 from the GCM 320 to be stored in the memory of the spare modem 220 along with configuration data (also provided by the GCM 320) for each of the primary modems 210 it is authorized to backup by the GCM 320.

The switchover command signal, including the primary modem ID, is received by the bootstrapper module 240, which, as noted above, can either be incorporated into the spare modem 220 or a separate element accessible to the spare modem 220. In any event, when the bootstrapper module 240 receives the switchover command from the GCM 320, identifying which of the primary modems 210 in the redundancy group 200 has become a failed primary modem 210′, the bootstrapper module 240 in the spare modem 220 provides a primary switching command to the MCS 260 of the spare modem 220 to use the stored configurations for the failed primary modem 210′ to activate the spare modem 220 to take over all operations for the failed primary modem 210′. Inasmuch as the configurations for the failed primary modem 210′ are prestored in the memory of the spare modem 220, the switchover takes place smoothly and quickly.

The failover from the failed primary modem 210′ to its designated spare modem 220 includes failure detection in the primary modem 210 which becomes the failed primary modem 210′. This also includes relaying the failed state from the failed modem 210′ to the GCM 320 and spare modem 220 for reconfiguration of the spare modem 220 using the pre-stored configurations for the failed modem 210′ to quickly takeover the operations of the failed primary modem 210′ with minimal disruptions in the satellite communication system.

As part of a fast switchover from the failed primary modem 210′ to its designated spare modem 220, it is essential that each of the primary modems 210 in the redundancy group 200 includes an arrangement to detect a failure in its hardware/software/firmware (HW/FW/SW) functioning in a rapid manner. To this end, each of the primary modems 210 has software (e.g., such as the MCS 260) that includes a module for monitoring the components of the primary modem 210 that it is a part of. In this regard, as noted above, the primary modems and the spare modem can include the same components, including a bootstrapper module 240 and an MCS 260, with the difference being whether the modem is designated by the GCT 310 and the GCM 320 to be a primary modem or a spare modem within a particular redundancy group 200.

In one implementation, the bootstrapper module 240 of one of the primary modems 210 implements alarm states where any failure of a hardware component or firmware processing in that primary modem 210 is detected. These alarm states can be captured in this implementation as an alarm in one or more alarm registers 270 in the primary modem (or external to but accessible by the primary modem). These alarm registers 270 can be periodically polled by software in the bootstrapper module 240 of each primary modem 210 to check the overall health of hardware and firmware processing for each of the primary modems 210 of the redundancy group 200. In implementations, the polling software in the MCS module 260 can poll critical alarms frequently with a polling period as low as few milliseconds or longer polling periods. If failure is detected, the failed state is relayed to a bootstrapper module 240 in a spare modem 220 which relays it to GCM 320.

If a defect exists in components of any of the primary modems 210 of a redundancy group 200, a critical alarm is detected by that modem, as noted above, and is immediately relayed to the GCM 320 using a health message. GCM 320 then determines the current state of all the primary modems 210 and spare the modem(s) 220 in the redundancy group 200 using such health messages that can be provided to the GCM 320 from all of the primary modems and the spare modem(s) 220 of the group 200. If the spare modem 220 is available (as determined by its current state), the GCM 320 initiates a switchover upon detection of a critical alarm in one of the health messages (indicating that one of the primary modems 210 has become a failed modem 210′). This is done by the GCM 320 commanding the spare modem 220 to take over operations of the failed primary modem 210′. The spare modem 220 then applies the configuration of the failed primary modem 210′ that has been prestored in the memory of the spare modem 220 to take over operations of the failed primary modem 210′. These operations can include the RF channels and the associated IP addresses of the failed primary modem 210′. A primary modem 210 can be regarded as failed or down if it is not available for carrying out its operations in the gateway. In particular, a primary modem 210 is considered not to be available if there is no response to a heartbeat message from the GCM 320.

A further description regarding the health messaging and alarm arrangements will be provided below with reference to Table 1. It is noted that, in implementations of the present disclosure, the health messages can be continuously provided by each of the primary modems 210 and the spare modem 220 to the GCM 320. These health messages will indicate whether the modem is “OK”, or has any type of health issue. In the example shown in Table 1, these health issues can be minor, major or critical. In each case, the GCM 320 will be continuously advised of the health status of each of the modems in the group 200 via these health messages.

More specifically, as noted above, if there is a failure of a primary modem 210 within a redundancy group 200, due to a hardware/firmware/software error which is not recoverable, the modem software detects these errors based on monitoring of the modem components and provides an alarm indicative of the failure of the modem. This alarm propagates the information that the modem has become a failed modem 210′ to the GCM via the bootstrapper module 240 in the failed primary module 210′. The GCM 320, in turn, sends a switchover message to the primary (failed) modem 210′ and to the redundant spare modem 220 indicating that the redundant spare modem 220 should take over the functionality. It is noted that the switchover message is provided not only to the spare modem 220, but also to the failed modem 210′ to advise the failed modem 210′ that the switchover operation is about to take place.

The modem software in each of the primary modems 210 (and in the spare modem 220) monitors all the firmware, hardware and software alarms and raises flags to indicate the presence of any alarm. As shown in Table 1, the alarms can be categorized as minor, major, and critical. An alarm is deemed critical if it pertains to an error of any modem firmware, hardware or software that will disrupt service/end-to-end traffic of the modem. In this case, the modem is regarded as a failed modem.

In an implementation of the present disclosure, upon detection of a critical alarm (e.g., level 3 in Table 1), the modem software can perform a verification by clearing the alarm register, waiting for a predetermined period of time (e.g., for 10 ms) and reading it again to see if the critical alarm is again detected and thus persists. If desired, this verification can be repeated (e.g., in an implementation it can be done at least three (3) times) before declaring critical alarm. On the detection and verification of the first critical alarm, the modem sends a health message to its bootstrapper module 240 indicating that the modem is in a critical state, and has become a failed primary modem 210′. It is noted that a spare modem 220 can also detect a critical alarm regarding its components and thus become a failed spare modem, either while it is in a standby state or during a failover state where it is taking over operations for a failed primary modem 210′. It is also noted that the monitoring software to detect failures in any of the modems can be in the bootstrapper module 240 or in another component within the modem such as the MCS 260 (or even external to the modem).

In an implementation of the present disclosure, each modem can periodically send health messages periodically, for example every 2 seconds, to the GCM 320 via the modem's bootstrapper module 240. Table 1 below shows a format that can be used for the health message and the description for each field. It is noted that this format is solely for purposes of example, and the present disclosure is not limited only to this format.

TABLE 1

| Field Name | Field Length | Description |
|---|---|---|
| MAC Header | 14 Octets | Standard MAC header. |
| IP Header | 40 Octets | Ipv6 header with the destination IP address as::1 (local Loopback address) |
| UDP Header | 8 Octets | UDP header with the destination port as port number for this message. |
| Message Type | 1 Octet | Value of 16 indicates this is an MCS/TDM Modem - Bootstrapper message |
| Version Number | 1 Octet | Set to 1 for this version |
| Sequence Number | 2 Octets | Counts the health message sent from MCS/TDM Modem to Bootstrapper |
| Modem state | 1 Octet | 0 - Ok |
| | | 1 - Minor |
| | | 2 - Major |
| | | 3 - Critical |
| | | 4 - Initializing |
| | | 5 - Firmware Downloading |
| | | Note: “Initializing” and “Firmware Downloading” are not applicable for |
| | | TDM Modem |
| Alarm Count | 1 Octet | N, where N is the number of alarms in the alarm list. Values from 1-20 |
| Alarm list | N * 256 | List of critical alarm names separated by Semi-colon |
| | Octets | |

The first three (3) fields in the message are headers required for packet routing. They are standard to the UDP protocol (User Datagram Protocol). The custom/application layer fields start from the fourth (4th) field of Table 1. The modem state field indicates the health of the modem being monitored. When the modem software detects a critical alarm, it will populate the modem state field with value “3” to indicate its critical state. This indicates that the modem has become a failed modem.

In one implementation of the present disclosure, the modem (MCS 260) confirms the fault internally before signaling it to bootstrapper module 240 which relays the modem fault condition to GCM 320. This implementation does not need an interrupt signal. In an alternative implementation of the present disclosure, when one of the bootstrapper modules 240 of a primary modems 210 (or the spare modem 220) relays a health status signal indicating determination of a fault condition in its corresponding primary modem to the gateway control manager GCM module 320, the GCM module 320 can be configured to provide an interrupt signal to the corresponding primary module. This interrupt signal can interrupt operations of the corresponding primary modem temporarily to allow time for the bootstrapper module 240 to provide a confirmation/verification signal to the GCM module 320 that the fault condition exists before the GCM module 320 commands that the switchover process be performed.

Each of the modem devices and their peers, such as inroute group managers (IGMs), (i.e., layer 2 network entities for direct interface), and code rate organizers (CROs), are given pre-generated fixed IPs (internet protocols) for communicating with its peer. The IPs are uniquely synthesized using unique device number associated with the device and are well known to all the entities in the network. As part of switchover re-configuration, the spare modem 220 dynamically applies the known IPs of the failed primary modem 210′ to its LAN interface. Hence the failover to the spare modem 220 is transparent to the modem's peer (e.g., IGM and CRO) as the communication IP stays the same between the peers after switchover.

Similarly, the current SRv6 routes are maintained by the primary modems 210 on the NAS (Network storage) as JSON (JavaScript Object Notation) files. Upon switchover, the spare modem 220 picks up the routes from the NAS for the corresponding failed primary modem 210′ and can apply it directly to a Linux stack and FPGAs (field-programmable gate arrays) for packet routing. Note that the spare modem does not need to wait to learn the route configuration from its master (SDN) controller and instead can use the current route information from the primary modems for fast reconfiguration.

As noted above, in addition to monitoring the critical alarm state of the primary modems 210, the GCM 320 also monitors periodic health messages from both the primary modems 210 and the spare modem 220. The receipt of the health messages can be used as an indicator that the modem services (both primary modems 210 and the spare modem(s)) are up and running. However, if the health messages are not received by the GCM 320 from one of the primary modems 210, it can be taken as service down indication for that primary modem 210 (in other words, that modem can be assumed to be a failed modem 210′ incapable of sending a health message), and switchover to the spare modem 220 for the group 200 may be initiated by the GCM 320.

Referring next to FIG. 3C, an example of a GCM module 320 is shown. In particular, the GCM 320 can be comprised of a preconfiguration engine 325 and a switchover engine 328. The preconfiguration engine 325 can operate to provide both redundancy group instructions and preconfiguration instructions to the spare modem 220. More specifically, a redundancy group configuration signal generator 330 receives the GCT input from the GCT 310 of FIG. 3A regarding mapping for the structure of the redundancy group, as described above. The redundancy group configuration signal generator 330 then provides a redundancy group instruction to advise the spare modem 220 that it has been selected to serve as the spare modem for the redundancy group 200. The redundancy group instruction further advises the spare modem 220 as to which primary modems 210 in the redundancy group 200 the spare modem 220 will be responsible for taking over operations for should any of the primary modems 210 become failed primary modems 210′.

The reconfiguration engine 325 also includes a preconfiguration instruction signal generator 340. This preconfiguration instruction signal generator 340 receives configurations from the primary modems 210 that are included in the redundancy group 200. The signal generator 340 then provides reconfiguration instructions to the spare modem 220 which will be stored in a memory for the spare modem 220 (i.e., the memory can either be in the spare modem 220 or an external memory accessible to the spare modem 220). This way, as discussed above, the spare modem 220 is preconfigured to be able to quickly reconfigure to takeover operations of a failed primary modem 210′.

The switchover engine 328 of the GCM 320 includes a switchover command signal generator 350 to generate the switchover command to the spare modem 220 when a failed primary modem 210′ is detected, as discussed above. The switchover engine 328 also includes a health signal analysis module 360 which provides the critical alarm to the switchover command signal generator 350 in order to trigger the generation of the switchover command to the spare modem 220. As shown in FIG. 3C, a health signal analysis module 360 receives the health signals from the primary modems 210, as discussed above. The health signal analysis module 360 can optionally generate interruption signals back to the primary modem 210 that has indicated a critical alarm, in order to command that primary modem 210 to confirm the critical alarm, as discussed above. The health signal analysis module 360 can be in the switchover engine 328 portion of the GCM 320, or an external module accessible to the switchover engine 328.

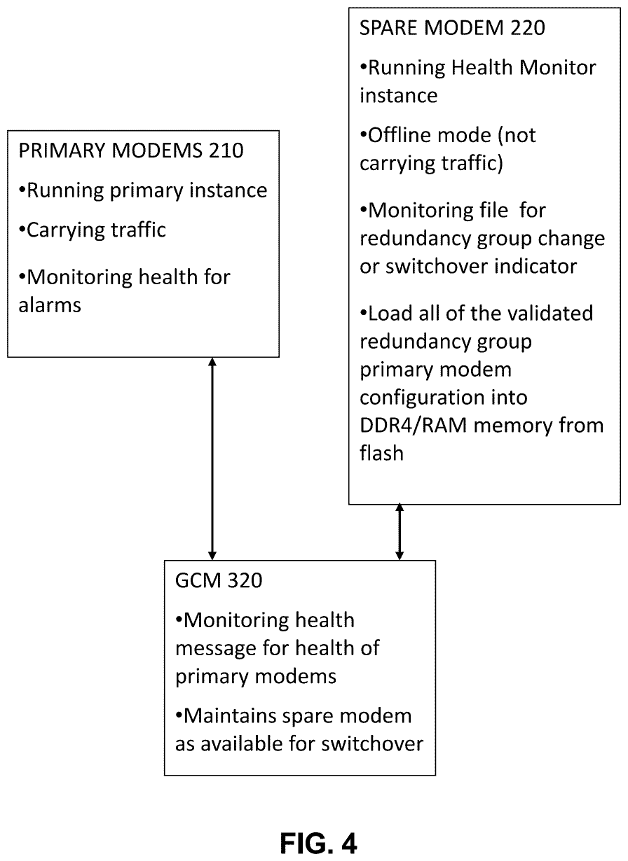

FIG. 4 shows the normal operations for a redundancy group configuration 200. Specifically, FIG. 4 shows the operations for each of the primary modems 210, the spare modem 220 and the GCM 320 when all of the primary modems 210 are operating properly. As shown in FIG. 4, during normal operation the primary modems 210 operate to run a primary instance, to carry traffic, and to monitor the health of the components, as described above, to determine whether any alarms are necessary to send to the GCM 320. The spare modem(s) 220, on the other hand, operates as a potential backup modem. Accordingly, the spare modem 220 runs health monitoring instances on its own components, monitors for redundancy group changes, or a switch over indicator signal from the GCM 320, and loads all of the validated redundancy group primary modem configurations into a memory, such as a DDR 4/RAM, memory (or other appropriate memory), as described above with regard to FIG. 3A. As such, during normal operation for a redundancy group 200, the spare modem 220 is in an off-line mode of not carrying traffic.

In the meantime, during normal operations of the redundancy group 200 shown in FIG. 4, the GCM 320 monitors health messages regarding the health of each of the primary modems 210. It can also monitor the health of the spare modem 220 via health messages from the spare modem's internal health monitoring to ensure that the spare modem 220 is available for switching over operations from any of the primary modems 210 which become failed primary modems 210′.

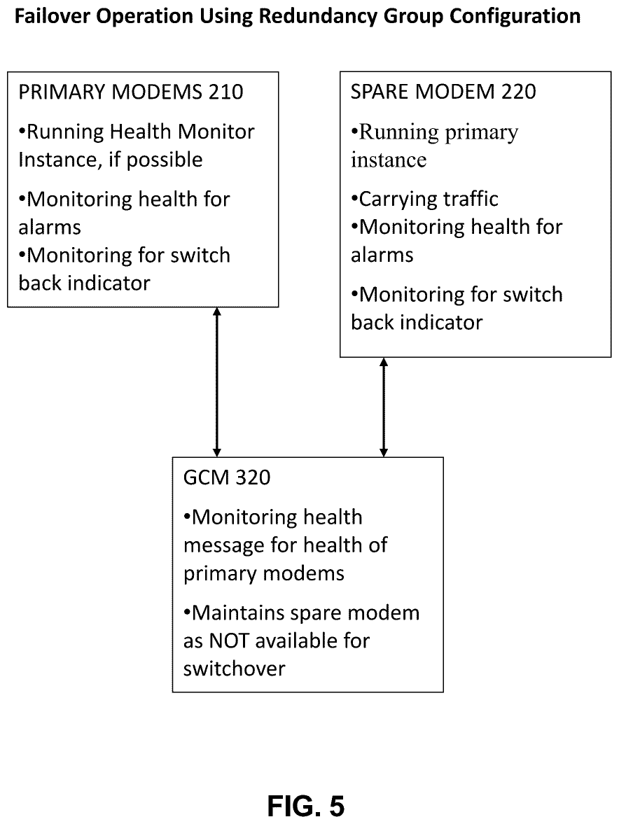

FIG. 5 shows the operations with regard to the primary modems 210, the spare modem 220 and the GCM 320 during a failover operation in which the GCM 320 has ordered the spare modem 220 to take over operations for a failed modem 210′. During this failover operation, the spare modem 220 becomes an online operating modem, running a primary instance corresponding to that previously run by the failed modem 210′. In other words, the spare modem 220 carries traffic during the failover operation. The spare modem 220 also monitors the health of its own components to determine if alarms are necessary to indicate that the spare modem 220 may have a faulty component. Finally, the spare modem 220 operates to monitor for a switch back indicator from the GCM 320. Such a switch back indicator is sent by the GCM 320 when it determines that the failed primary modem 210′ has been repaired and can return to carrying traffic. Thus, the switch back indicator advises the spare modem 220 that it can revert to its role as a backup modem and stop carrying traffic to return to the normal operation status shown in FIG. 4.

In the meantime, the primary modems 210 run health monitoring instances, if possible, and monitor the health of their internal components for determining if alarms are necessary. The failed primary modem 210′ also monitors for a switch back indicator from the GCM 320. As noted above, such a switchback indicator would advise the failed primary modem 210′ that it is allowed to resume its normal operations based on its having been repaired. Such a successful repair can be recognized based on health signals sent to the GCM 320 by the failed primary modem 210′.

As also shown in FIG. 5, during the failover operation the GCM 320 operates to monitor health messages regarding the health of the primary modems 210 which are not currently failed primary modems 210′. The GCM 320 also maintains a record that the spare modem 220 currently being used in the failover operation for the failed primary modem 210′ is not available for switching over to take over operations of any other primary modems 210.

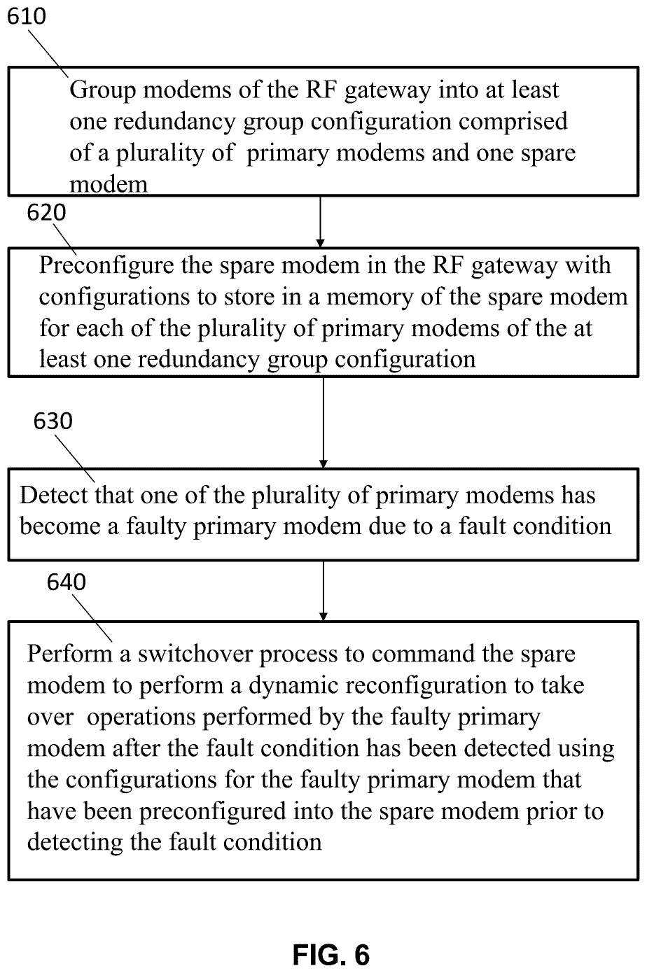

FIG. 6 shows a flowchart of an example method for backing up RF gateway modems in a satellite communication system in accordance with aspects of the disclosure. Beginning with step 610, modems 210 of the RF gateways 112 are grouped into at least one redundancy group configuration (e.g., see the redundancy group 200 in FIG. 2) comprised of a plurality of primary modems 210 and at least one spare modem 220. In step 620, the spare modems 220 in each of the redundancy groups 200 are preconfigured with configurations to store in a memory of each of the spare modems for each of the plurality of primary modems of the corresponding redundancy group configuration. In step 630, within each redundancy group 200, it can be detected that one of the plurality of primary modems in the redundancy group 200 has become a faulty primary modem due to a fault condition (e.g., the primary modem is not currently available for operations. This detection can be done by bootstrapper modules 240 within the spare modems themselves, as shown in FIGS. 3A and 3B. In step 640, a switchover process is performed to command a spare modem 220 to perform a dynamic reconfiguration to take over operations performed by the faulty primary modem if the fault condition has been detected in one of the primary modems 210 within the same redundancy group 200 using the configurations for the faulty primary modem that have been preconfigured into the spare modem prior to detecting the fault condition.

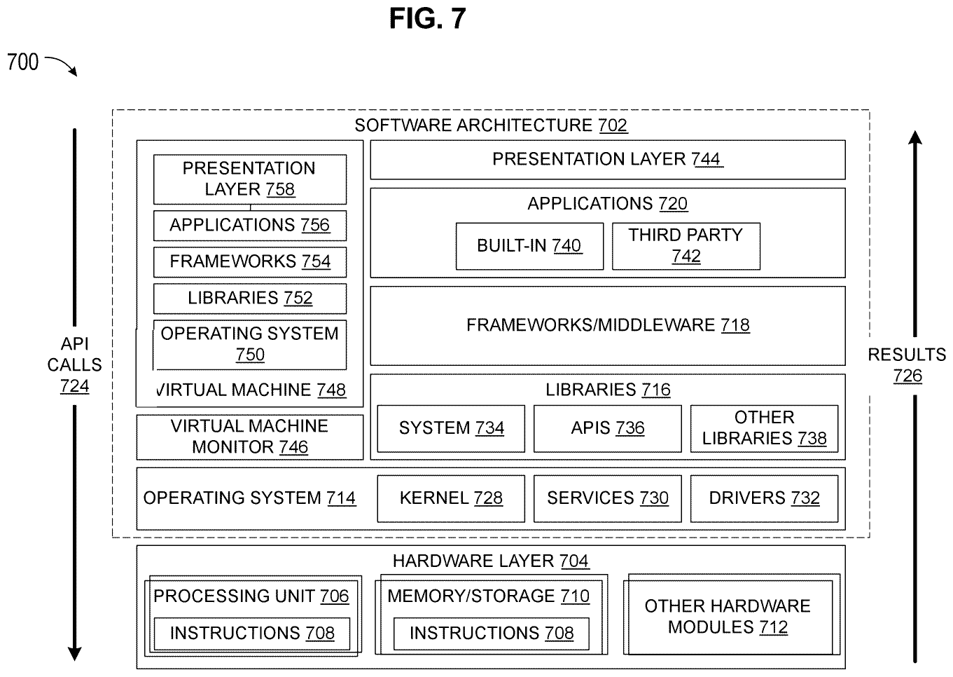

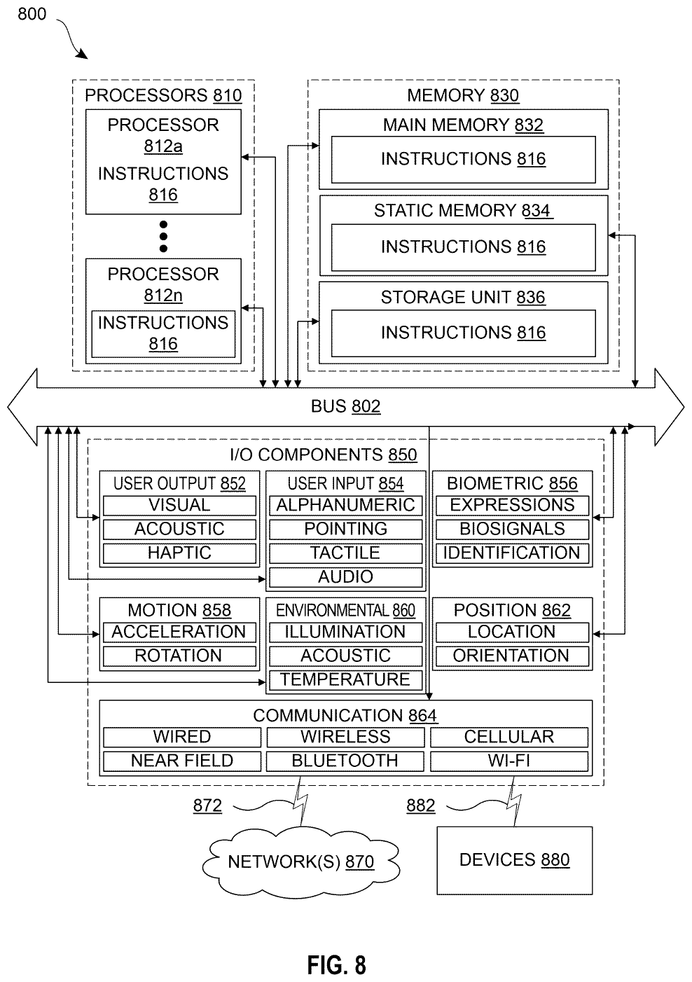

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, components of the satellite communication system 100 of FIG. 1. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712, such as field-programmable gate array chips (FPGAs) that can be used for modems, and various RF components. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers (such as RF analog and baseband digital component drivers), audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to a communication protocol application, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per sc.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for providing modem backup in a radio frequency (RF) gateway of a satellite communication system comprising:
a processor; and
a memory in communication with the processor, the memory comprising executable instructions that, when executed by the processor alone or in combination with other processors, cause the data processing system to perform functions of:
grouping modems of the RF gateway into at least one redundancy group comprised of a plurality of primary modems and at least one spare modem;
preconfiguring the at least one spare modem in the RF gateway with primary modem configurations for each of the plurality of primary modems of the at least one redundancy group;
detecting that one of the plurality of primary modems has become a failed primary modem due to a fault condition; and
performing a switchover process to command the at least one spare modem to perform a dynamic reconfiguration to take over operations performed by the failed primary modem after the fault condition has been detected using the configurations for the failed primary modem that have been preconfigured into the at least one spare modem prior to detecting the fault condition.

2. The data processing system of claim 1, wherein each of the primary modems of the at least one redundancy group includes a bootstrapper module configured to monitor a health status of its corresponding primary modem, and wherein preconfiguring the at least one spare modem comprises storing the primary modem configurations in a memory which is accessible to the spare modem.

3. The data processing system of claim 2, wherein each of the bootstrapper modules is configured to relay the health status of its corresponding primary modem to a gateway control manager (GCM) module configured to receive the health status from each of the primary modems of the at least one redundancy group.

4. The data processing system of claim 3, wherein the GCM module is configured to command and control switchover from the failed primary modem for which the fault condition has been detected to the spare modem based on the health status provided by the bootstrapper module of the failed primary modem.

5. The data processing system of claim 3, wherein the configurations for each of the primary modems of the redundancy group include a device ID of the corresponding primary modem.

6. The data processing system of claim 5, wherein the GCM module is configured to provide the device ID of the failed primary modem to the at least one spare modem, and the at least one spare modem is configured to use the device ID of the failed primary modem received from the GCM module to download the configurations for the failed primary modem stored in the memory of the at least one spare modem.

7. The data processing system of claim 5, wherein the configurations for each of the primary modems of the redundancy group include at least one of channel configurations, RF configurations, Internet Protocol (IP) addresses, data management configurations, path IPs, programming of Local Area Network (LAN) interfaces, and Segment Routing IP version 6 (Srv6) protocol route configurations.

8. The data processing system of claim 3, wherein the GCM module is configured to receive a flow diagram of the redundancy group from a gateway configuration tool (GCT) providing mapping of the plurality of primary modems and the at least one spare modem of the redundancy group, and to provide the mapping to the spare modem containing a list of primary modems that the at least one spare modem is authorized to take over for upon failure of one of the primary modems on the list.

9. The data processing system of claim 8, wherein each of the primary modems of the redundancy group includes an alarm register configured to capture an alarm when the bootstrapper module in the corresponding primary modem detects a failure of a component of the corresponding primary modem while the bootstrapper module is monitoring the health status of the corresponding primary modem.

10. The data processing system of claim 9, wherein each of the primary modems of the redundancy group includes a polling module configured to periodically poll the alarm register to determine if the alarm register has captured the alarm indicating detection of a failure of a component of the corresponding primary modem.

11. The data processing system of claim 9, wherein the bootstrapper module of the failed primary modem in which the failure of the component has been detected and captured as an alarm in the corresponding alarm register is configured to pass the alarm to the GCM module in a health message indicating that the health status of the failed primary modem includes the failure of the component.

12. The data processing system of claim 3, wherein when one of the bootstrapper modules relays a health status signal indicating determination of a fault condition in its corresponding primary modem to the gateway control manager (GCM) module, the GCM module is configured to provide an interrupt signal to the corresponding primary modem to interrupt operations of the corresponding primary modem temporarily to allow time for the bootstrapper module to provide a confirmation signal to the GCM module that the fault condition exists before GCM module commands that the switchover process be performed.

13. The data processing system of claim 1, wherein a gateway control manager (GCM) module is configured to monitor availability of each of the primary modems in the at least one redundancy group using heartbeat messages and to initiate a switchover operation to the spare modem in the at least one redundancy group if one of the primary modems in the at least one redundancy group is unresponsive to the heartbeat messages.

14. A method of providing modem backup in a radio frequency (RF) gateway of a satellite communication system comprising:
grouping modems of the RF gateway into at least one redundancy group comprised of a plurality of primary modems and at least one spare modem;
preconfiguring the spare modem in the RF gateway with for each of the plurality of primary modems of the at least one redundancy group;
detecting that one of the plurality of primary modems has become a failed primary modem due to a fault condition; and
performing a switchover process to command the at least one spare modem to perform a dynamic reconfiguration to take over operations performed by the failed primary modem after the fault condition has been detected using configurations for the failed modem that have been preconfigured into the at least one spare modem prior to detecting the fault condition.

15. The method of claim 14, wherein each of the primary modems of the group includes a bootstrapper module configured to monitor a health status of its corresponding primary modem, and wherein the preconfiguring the at least one spare modem comprises storing the primary modem configurations in a memory which is accessible to the spare modem.

16. The method of claim 15, wherein each of the bootstrapper modules is configured to relay the health status of its corresponding primary modem to a gateway control manager (GCM) module configured to receive the health status from each of the primary modems of the group.

17. The method of claim 16, wherein the GCM module is configured to command and control switchover from the failed primary modem for which the fault condition has been detected to the at least one spare modem based on the health status provided by the bootstrapper module of the failed primary modem.

18. The method of claim 16, wherein the configurations for each of the primary modems of the redundancy group include a device ID of the corresponding primary modem.

19. The method of claim 18, wherein the GCM module is configured to provide the device ID of the failed primary modem to the spare modem, and the at least one spare modem is configured to use the device ID of the failed primary modem received from the GCM module to download the configurations for the failed primary modem stored in the memory of the at least one spare modem.

20. The method of claim 18, wherein the configurations for each of the primary modems of the redundancy group include at least one of channel configurations, Internet Protocol (IP) addresses, data management configurations, path IPs, programming of Local Area Network (LAN) interfaces, and Segment Routing IP version 6 (Srv6) protocol route configurations.

21. The method of claim 16, wherein the GCM module is configured to receive a flow diagram of the redundancy group from a gateway configuration tool (GCT) providing mapping of the plurality of primary modems and the at least one spare modem of the redundancy group, and to provide the mapping to the spare modem containing a list of primary modems that the at least one spare modem is authorized to take over for upon failure of one of the primary modems on the list.

22. The method of claim 16, wherein a gateway control manager (GCM) module is configured to monitor availability of each of the primary modems in the at least one redundancy group using heartbeat messages and to initiate a switchover operation to the spare modem in the at least one redundancy group if one of the primary modems in the at least one redundancy group is unresponsive to the heartbeat messages.
